(19) United States
(12) Patent Application Publication
(10) Pub. No.: US 2009/0095824 A1
(43) Pub. Date: Apr. 16, 2009

(54) Fuel Injection Control Device For Internal Combustion Engine

(75) Inventors: Yoshinori Futonagane, Shizuoka (JP); Fumihiro Okumura, Shizuoka (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOYOTA JIDOSHA KABUSHIKI KAISHA, Aichi (JP)

(21) Appl. No.: 12/282,708

(22) PCT Filed: Feb. 20, 2007
(86) PCT No.: PCT/JP2007/053452

§ 371 Date: Sep. 12, 2008

(30) Foreign Application Priority Data
Mar. 14, 2006 (JP) 2006-069091

(51) Int. Cl. F02M 61/00

(52) U.S. Cl. 239/533.12

(57) ABSTRACT

When fuel injection is carried out, an amount of deposit produced newly around a second injection hole is estimated on the basis of an amount of fuel injected from at least the first injection hole. The amount of produced deposit estimated every time the first fuel injection is carried out is integrated. When the integrated value of the amount of deposit reaches a set value, fuel injection in which the second injection hole is used is carried out to remove the deposit.

### TECHNICAL FIELD

The present invention relates to a fuel injection control device for an internal combustion engine.

### BACKGROUND ART

In a fuel injector for injecting fuel directly into a cylinder, which has a first injection hole and a second injection hole, a fuel injection, in which the first injection hole is used and the second injection hole is not used, and a fuel injection, in which both of the first injection hole and the second injection hole are used, are changed over in accordance with the engine operating condition or the amount of injected fuel.

In the fuel injection, in which the first injection hole is used and the second injection hole is not used, carbon deposit is easily produced around the second injection hole. Accordingly, to prevent blocking the second injection hole by a deposit, when fuel injection is continued for a predetermined period, it is suggested that fuel injection in which the second injection hole is used is forcibly carried out (for example, refer to Japanese Unexamined Patent Publication No. 2002-310042).

### DISCLOSURE OF THE INVENTION

In the above-mentioned art, even if the fuel injection, in which the first injection hole is used and the second injection hole is not used, is continued for the predetermined period, a large amount of carbon deposit may not be deposited around the second injection hole. In such a case, if the fuel injection, in which the second injection hole is used, is forcibly carried out, fuel consumption is unnecessarily deteriorated.

Therefore, an object of the present invention is to provide a fuel injection control device for an internal combustion engine which makes a fuel injector for injecting fuel directly into the cylinder, which has a first injection hole and a second injection hole, change over a fuel injection, in which the first injection hole is used and the second injection hole is not used, and a fuel injection, in which both of the first injection hole and the second injection hole are used, which device can prevent from blocking the second injection hole by the deposit and can restrain the unnecessary deterioration of fuel consumption.

According to the present invention described in claim 1, there is provided a fuel injection control device for an internal combustion engine which controls a fuel injector for injecting fuel directly into the cylinder, which has a first injection hole and a second injection hole, so as to change over a first fuel injection, in which the first injection hole is used and the second injection hole is not used, and a second fuel injection, in which both of the first injection hole and the second injection hole are used, characterized in that when the first fuel injection is carried out, an amount of deposit produced newly around the second injection hole is estimated on the basis of at least an amount of fuel injected from the first injection hole, the amount of deposit produced is estimated every time the first fuel injection is carried out and is integrated, when the integrated value of the amount of deposit reaches a first set value, a fuel injection in which the second injection hole is used is carried out to remove the deposit.

According to the present invention described in claim 2, there is provided a fuel injection control device for an internal combustion engine according to claim 1, characterized in that when fuel is injected from the second injection hole, an amount of deposit removed from around the second injection hole is estimated on the basis of at least an amount of fuel injected from the second injection hole, the estimated amount of removed deposit is subtracted from the integrated value of the amount of deposit.

According to the present invention described in claim 3, there is provided a fuel injection control device for an internal combustion engine according to claim 1 or 2, characterized in that when a measured or estimated temperature near the second injection hole of the fuel injector becomes equal to or higher than a set temperature, the integrated value of the amount of deposit is decreased.

According to the present invention described in claim 4, there is provided a fuel injection control device for an internal combustion engine according to any one of claims 1-3, characterized in that the fuel injection when the integrated value of the amount of deposit reaches the first set value, in which the second injection hole is used, is carried out near an intake or compression top dead center when combustion is stopped temporarily.

According to the present invention described in claim 5, there is provided a fuel injection control device for an internal combustion engine according to any one of claims 1-3, characterized in that the fuel injection when the integrated value of the amount of deposit reaches the first set value, in which the second injection hole is used, is carried out in an expansion or exhaust stroke when exhaust gas that has an air-fuel ratio richer than the stoichiometric air-fuel ratio is required for the engine exhaust system.

According to the present invention described in claim 6, there is provided a fuel injection control device for an internal combustion engine according to any one of claims 1-5, characterized in that in the fuel injection when the integrated value of the amount of deposit reaches the first set value, in which the second injection hole is used, an amount of deposit removed from around the second injection hole is estimated on the basis of at least an amount of fuel injected from the second injection hole, the estimated amount of removed deposit is subtracted from the integrated value of the amount of deposit, the fuel injection when the integrated value of the amount of deposit reaches the first set value, in which the second injection hole is used, is carried out continuously until the integrated value of the amount of deposit becomes a second set value larger than zero and smaller than the first set value.

According to the present invention described in claim 7, there is provided a fuel injection control device for an internal combustion engine according to any one of claims 1-5, characterized in that in the fuel injection when the integrated value of the amount of deposit reaches the first set value, in which the second injection hole is used, an amount of deposit removed from around the second injection hole is estimated on the basis of at least an amount of fuel injected from the second injection hole, the estimated amount of removed deposit is subtracted from the integrated value of the amount of deposit, the fuel injection when the integrated value of the amount of deposit reaches the first set value, in which the second injection hole is used, is carried out continuously until the integrated value of the amount of deposit becomes zero.

According to the present invention described in claim 8, there is provided a fuel injection control device for an internal combustion engine according to any one of claims 1-5, characterized in that in the fuel injection when the integrated value of the amount of deposit reaches the first set value, in which the second injection hole is used, an amount of deposit removed from around the second injection hole is estimated on the basis of at least an amount of fuel injected from the second injection hole, the estimated amount of removed deposit is subtracted from the integrated value of the amount of deposit, the fuel injection when the integrated value of the amount of deposit reaches the first set value, in which the second injection hole is used, is carried out continuously until a set period elapses after the integrated value of the amount of deposit becomes zero.

According to the present invention described in claim 9, there is provided a fuel injection control device for an internal combustion engine according to claim 6, characterized in that when a first fuel injection pattern, in which the fuel injection when the integrated value of the amount of deposit reaches the first set value, in which the second injection hole is used, is carried out continuously until the integrated value of the amount of deposit reaches the second set value, is carried out one or several set time(s), a second fuel injection pattern, in which the fuel injection when the integrated value of the amount of deposit reaches the first set value, in which the second injection hole is used, is carried out continuously until a set period elapses after the integrated value of the amount of deposit becomes zero, is carried out.

According to the present invention described in claim 10, there is provided a fuel injection control device for an internal combustion engine according to any one of claims 1-5, characterized in that the integrated value of the amount of deposit is corrected so as to increase due to an estimated error of the integrated value.

According to the present invention described in claim 11, there is provided a fuel injection control device for an internal combustion engine according to claim 6, characterized in that the integrated value of the amount of deposit is corrected so as to increase due to an estimated error of the integrated value.

According to the present invention described in claim 12, there is provided a fuel injection control device for an internal combustion engine according to claim 11, characterized in that when a first fuel injection pattern, in which the fuel injection when the integrated value of the amount of deposit reaches the first set value, in which the second injection hole is used, is carried out continuously until the integrated value of the amount of deposit reaches the second set value, is carried out one time or set times, a second fuel injection pattern, in which the fuel injection when the integrated value of the amount of deposit reaches the first set value, in which the second injection hole is used, is carried out continuously until the integrated value of the amount of deposit becomes zero, is carried out.

According to the present invention described in claim 13, there is provided a fuel injection control device for an internal combustion engine according to claim 7, characterized in that the integrated value of the amount of deposit is corrected so as to increase due to an estimated error of the integrated value.

According to the fuel injection control device for an internal combustion engine described in claim 1, when the first fuel injection, in which the first injection hole is used and the second injection hole is not used, is carried out, a part of fuel injected from the first injection hole adheres around the second injection hole and carbon deposit is produced. Accordingly, an amount of deposit produced newly around the second injection hole is estimated on the basis of at least an amount of fuel injected from the first injection hole, and the amount of produced deposit estimated every when the first fuel injection is carried out is integrated. When the integrated value of the amount of deposit reaches a first set value, a fuel injection in which the second injection hole is used is carried out to remove the deposit. Therefore, when a large amount of carbon deposit is not deposited around the second injection hole, the fuel injection for removing the deposit, in which the second injection hole is used, is not carried out, and thus the unnecessary deterioration of fuel consumption is restrained.

According to the fuel injection control device described in claim 2, in the fuel injection control device for an internal combustion engine according to claim 1, when fuel is injected from the second injection hole, an amount of deposit removed from around the second injection hole is estimated on the basis of at least an amount of fuel injected from the second injection hole, the estimated amount of removed deposit is subtracted from the integrated value of the amount of deposit. Therefore, if the second fuel injection, in which both of the first injection hole and the second injection hole are used, is carried out before the integrated value of the amount of deposit reaches the first set value, the integrated value of the amount of deposit is decreased and does not easily reach the set value. Thus, implementation of the forced fuel injection, in which the second injection hole is used, is restrained and the unnecessary deterioration of fuel consumption is surely restrained.

According to the fuel injection control device described in claim 3, in the fuel injection control device for an internal combustion engine according to claim 1 or 2, when a measured or estimated temperature near the second injection hole of the fuel injector becomes equal to or higher than a set temperature, the integrated value of the amount of deposit is decreased because the deposit around the second injection hole burns or comes off the fuel injector. Therefore, because the integrated value of the amount of deposit does not easily reach the set value, thus implementation of the forced fuel injection, in which the second injection hole is used, is restrained and thus the unnecessary deterioration of fuel consumption is surely restrained.

According to the fuel injection control device described in claim 4, in the fuel injection control device for an internal combustion engine according to any one of claims 1-3, the fuel injection when the integrated value of the amount of deposit reaches the first set value, in which the second injection hole is used, is carried out near an intake or compression top dead center when combustion is stopped temporarily. Therefore, the fuel injected from the second injection hole does not unnecessarily contribute combustion and sticks hardly on the cylinder-bore. Thus, it is restrained that the engine oil is diluted by the fuel stuck on the cylinder-bore.

According to the fuel injection control device described in claim 5, in the fuel injection control device for an internal combustion engine according to any one of claims 1-3, the fuel injection when the integrated value of the amount of deposit reaches the first set value, in which the second injection hole is used, is carried out in an expansion or exhaust stroke when exhaust gas that has an air-fuel ratio richer than the stoichiometric air-fuel ratio is required for the engine exhaust system. Therefore, the fuel injected from the second injection hole is effectively utilized to form the exhaust gas of the rich air-fuel required for the engine exhaust system.

According to the fuel injection control device described in claim 6, in the fuel injection control device for an internal combustion engine according to any one of claims 1-5, the fuel injection when the integrated value of the amount of deposit reaches the first set value, in which the second injection hole is used, an amount of deposit removed from around the second injection hole is estimated on the basis of at least an amount of fuel injected from the second injection hole, the estimated amount of removed deposit is subtracted from the integrated value of the amount of deposit, this forced fuel injection is carried out continuously until the integrated value of the amount of deposit becomes a second set value larger than zero and smaller than the first set value. The amount of deposit around the second injection hole that is decreased to the second set value does not affect the fuel injection. Accordingly, in comparison with a case where the forced fuel injection further continues to remove the larger amount of deposit, fuel consumption can be decreased.

According to the fuel injection control device described in claim 7, in the fuel injection control device for an internal combustion engine according to any one of claims 1-5, the fuel injection when the integrated value of the amount of deposit reaches the first set value, in which the second injection hole is used, an amount of deposit removed from around the second injection hole is estimated on the basis of at least an amount of fuel injected from the second injection hole, the estimated amount of removed deposit is subtracted from the integrated value of the amount of deposit, this forced fuel injection is carried out continuously until the integrated value of the amount of deposit becomes zero. Therefore, even if there is a tendency in which the integrated value of the deposit is estimated smaller than the actual value, the deposit around the second injection hole can be almost removed after the forced fuel injection is carried out. Accordingly, for example, in comparison with a case where the forced fuel injection continues until the integrated value reaches the second set value, a period until the integrated value of the deposit reaches the first set value after the forced fuel injection is stopped is lengthened and thus possibility in which the second fuel injection which is not forced is carried out for this period increases. Therefore, even if the integrated value is estimated smaller than the actual value, possibility in which a large amount of carbon deposit is deposited around the second injection hole can be decreased.

According to the fuel injection control device described in claim 8, in the fuel injection control device for an internal combustion engine according to any one of claims 1-5, the fuel injection when the integrated value of the amount of deposit reaches the first set value, in which the second injection hole is used, an amount of deposit removed from around the second injection hole is estimated on the basis of at least an amount of fuel injected from the second injection hole, the estimated amount of removed deposit is subtracted from the integrated value of the amount of deposit, this forced fuel injection is carried out continuously until a set period elapses after the integrated value of the amount of deposit becomes zero. Therefore, even if there is a tendency in which the integrated value of the deposit is estimated smaller than the actual value, the deposit around the second injection hole can be perfectly removed by the forced fuel injection for the set period. Accordingly, the integrated value of the deposit can be reset zero corresponding to the actual value at this time and thereafter the integrated value of the deposit is not very different from the actual value.

According to the fuel injection control device described in claim 9, in the fuel injection control device for an internal combustion engine according to claim 6, when a first fuel injection pattern, in which the fuel injection when the integrated value of the amount of deposit reaches the first set value, in which the second injection hole is used, is carried out continuously until the integrated value of the amount of deposit reaches the second set value, is carried out one time or set times, a second fuel injection pattern, in which the fuel injection when the integrated value of the amount of deposit reaches the first set value, in which the second injection hole is used, is carried out continuously until a set period elapses after the integrated value of the amount of deposit becomes zero, is carried out. Therefore, in the first pattern of the forced fuel injection, fuel consumption can be decreased and in the second pattern of the forced fuel injection, the integrated value can be reset to zero corresponding to the actual value at this time. Thus, even if there is a tendency in which the integrated value of the deposit is estimated smaller than the actual value, the integrated value of the deposit is not very different from the actual value.

According to the fuel injection control device described in claims 10 and 11, in the fuel injection control device for an internal combustion engine according to any one of claims 1-5 or claim 6, the integrated value of the amount of deposit is corrected so as to increase due to an estimated error of the integrated value. Therefore, even if the integrated value of the deposit is estimated smaller than the actual value, the integrated value is corrected so as to increase. Accordingly, when the actual amount of deposit around the second injection hole exceeds the first set value, it is restrained that the forced fuel injection is not carried out.

According to the fuel injection control device described in claim 12, in the fuel injection control device for an internal combustion engine according to claim 11, a first fuel injection pattern, in which the fuel injection when the integrated value of the amount of deposit reaches the first set value, in which the second injection hole is used, is carried out continuously until the integrated value of the amount of deposit reaches the second set value, is carried out one time or set times, a second fuel injection pattern, in which the fuel injection when the integrated value of the amount of deposit reaches the first set value, in which the second injection hole is used, is carried out continuously until the integrated value of the amount of deposit becomes zero, is carried out. Therefore, in the first pattern of the forced fuel injection, fuel consumption can be decreased and in the second pattern of the forced fuel injection which is carried continuously until the integrated value corrected so as to increase become zero, the deposit around the second injection hole is perfectly removed and the integrated value can be reset to zero corresponding to the actual value at this time. Thus, even if there is a tendency in which the integrated value of the deposit is estimated smaller than the actual value, the integrated value of the deposit is not very different from the actual value.

According to the fuel injection control device described in claim 13, in the fuel injection control device for an internal combustion engine according to claim 7, the integrated value of the amount of deposit is corrected so as to increase due to an estimated error of the integrated value. Therefore, even if there is a tendency in which the integrated value of the deposit is estimated smaller than the actual value, in the forced fuel injection which is carried continuously until the integrated value corrected so as to increase become zero, the deposit around the second injection hole is perfectly removed and the integrated value can be reset to zero corresponding to the actual value at this time. Thus, the integrated value of the deposit is not very different from the actual value.

### BRIEF DESCRIPTION OF THE DRAWINGS

FIG. 1 is a schematic sectional view showing a tip portion of a first fuel injector controlled by a fuel injection control device according to the present invention.

FIG. 2 is a schematic sectional view showing a tip portion of a second fuel injector controlled by the fuel injection control device according to the present invention.

FIG. 3 is a flow-chart for a forced fuel injection carried out by the fuel injection control device according to the present invention.

FIG. 4 is a map showing an amount of produced deposit.

FIG. 5 is a map showing an amount of removed deposit.

FIG. 6 is a map showing a temperature near the second fuel injection hole.

FIG. 7 is a time-chart showing a varying of an integrated value of an amount of deposit when the control of the flow-chart of FIG. 3 is carried out.

FIG. 8 is a time-chart showing a varying of an integrated value of an amount of deposit when another control different from the control of the flow-chart of FIG. 3 is carried out.

FIG. 9 is a time-chart showing a varying of an integrated value of an amount of deposit when further another control different from the control of the flow-chart of FIG. 3 is carried out.

FIG. 10 is a time-chart showing a varying of an estimated error of an integrated value of an amount of deposit.

FIG. 11 is a part of a modification of the flow-chart of FIG. 3.

FIG. 12 is a time-chart showing a varying of an integrated value of an amount of deposit when the control of the flow-chart of FIG. 11 is carried out.

### BEST MODE FOR CARRYING OUT THE INVENTION

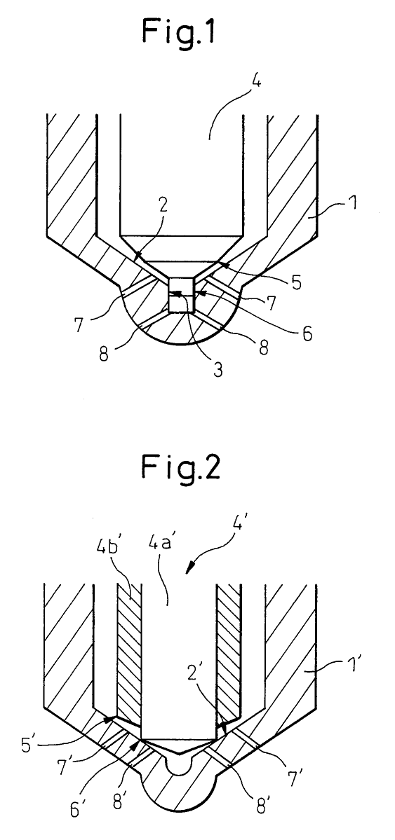

FIG. 1 is a schematic sectional view showing a tip portion of a first fuel injector controlled by a fuel injection control device for an internal combustion engine according to the present invention. The first fuel injector is used to inject fuel directly into the cylinder, for example, in a diesel engine or a direct fuel injection type spark-ignition internal combustion engine. In FIG. 1, reference numeral 1 is a body of the fuel injector. In the body 1, a first seat portion 2 having a shape of a frustum of cone and a second seat portion 3 having a shape of column positioned on the tip side of the first seat portion 2 are formed. Reference numeral 4 is a valve body which can move up and down in the body 1. At the tip portion of the valve body, a first seal portion 5 abutting on the first seat portion 2 and a second seal portion 6 fitting into the second seat portion 3 are formed.

At the first seat portion 2 of the body 1, plural first injection holes 7 are radially formed on the tip side of the abutting position of the first seal portion 5 of the valve body 4. At the second seat portion 3, plural second injection holes 8 are radially formed on the tip side of the fitting position of the second seal portion 6. FIG. 1 shows a condition in which the valve body 4 is slightly lifted. In this condition, the first seal portion 5 of the valve body 4 is separated from the first seat portion 2 whereas the second seal portion 6 of the valve body 4 fits into the second seat portion 3. Therefore, high pressure fuel supplied within the body 1 is injected from the first injection holes 7 but is not injected from the second injection holes 8. When the valve body 4 is further lifted, the second seal portion 6 of the valve body 4 is separated from the second seat portion 3 and therefore the high pressure fuel is not injected from only the first injection holes 7 but also the second injection holes 8.

Thus, by controlling a lifting amount of the valve body 4, a first fuel injection, in which the first injection holes 7 are used and the second injection holes 8 are not used, and a second fuel injection, in which both of the first injection holes 7 and the second injection holes 8 are used, can be changed over. For example, when a required amount of injected fuel is smaller than a set amount, if the first fuel injection is carried out, an opening period of the valve body 4 does not become too short. On the other hand, when the required amount of injected fuel is equal to or larger than the set amount, if the second fuel injection is carried out, the injected fuel can be widely dispersed in the combustion chamber formed on the top surface of the piston and the opening period of the valve body 4 does not become too long.

FIG. 2 is a schematic sectional view showing a tip portion of a second fuel injector controlled by the fuel injection control device for an internal combustion engine according to the present invention. The second fuel injector is also used to inject fuel directly into the cylinder, for example, in a diesel engine or a direct fuel injection type spark-ignition internal combustion engine. In FIG. 2, reference numeral 1′ is a body of the fuel injector. In the body 1′, a first seat portion 2′ having a shape of a frustum of cone is formed. Reference numeral 4′ is a valve body which can move up and down in the body 1′. The valve body 4′ has an inside member 4a′ and an outside member 4b′ fitting on the outside of the inside member 4a′. At the tip portion of the outside member 4b′, a first seal portion 5′ abutting on the seat portion 2′ is formed. At the tip portion of the inside member 4a′, a second seal portion 6′ fitting into the seat portion 2′ is formed.

At the seat portion 2′ of the body 1′, plural first injection holes 7′ are radially formed between the abutting position of the first seal portion 5′ of the outside member 4b′ of the valve body 4′ and the abutting position of the second seal portion 6′ of the inside member 4a′ of the valve body 4′, and plural second injection holes 8′ are radially formed on the tip side of the abutting position of the second seal portion 6′. The outside member 4b′ of the valve body 4′ can be lifted independently of the inside member 4a′. FIG. 2 shows a condition in which only the outside member 4b′ of the valve body 4′ is lifted. In this condition, the first seal portion 5′ of the outside member 4b′ of the valve body 4′ is separated from the seat portion 2′ whereas the second seal portion 6′ of the inside member 4a′ of the valve body 4′ abuts on the seat portion 2′. Therefore, high pressure fuel supplied within the body 1′ is injected from the first injection holes 7′ but is not injected from the second injection holes 8′. When the outside member 4b′ of the valve body 4′ is further lifted, the outside member 4b′ abuts on the step portion (not shown) of the inside member 4a′ and thus the outside member 4b′ with the inside member 4a′ is lifted. Therefore, the second seal portion 6′ of the inside member 4a′ is separated from the seat portion 2′. In this condition, the high pressure fuel is not injected from only the first injection holes 7′ but also the second injection holes 8′.

Thus, according to also the second fuel injector, by controlling a lifting amount of the valve body 4′, the first fuel injection, in which the first injection holes 7′ are used and the second injection holes 8′ are not used, and the second fuel injection, in which both of the first injection holes 7′ and the second injection holes 8′ are used, can be changed over.

Incidentally, in the first and second fuel injectors, when the second fuel injection in which both of the first injection holes 7 or 7′ and the second injection holes 8 or 8′ are used is carried out, no problem occurs. However, when the first fuel injection in which the first injection holes 7 or 7′ are used and the second injection holes 8 or 8′ are not used is carried out, a part of fuel injected from the first injection holes 7 or 7′ adheres around the second injection holes 8 or 8′ and the carbon deposit is produced from the adhered fuel. Therefore, when the first fuel injection is continued, the second injection holes 8 or 8′ are blocked or throttled by the grown deposit and thus a good fuel injection from the second injection holes 8 or 8′ cannot be carried out.

Accordingly, when the first fuel injection has been continued for a predetermined period, it is determined that the deposit around the second injection holes 8 or 8′ has grown enough to obstruct a good fuel injection and thus a fuel injection in which the second injection holes 8 or 8′ are used is usually forced to remove the deposit. Such a fuel injection is carried out on an exhaust stroke and the like such that combustion does not receive a bad influence and fuel is wasted. When the first fuel injection has been continued for a predetermined period, if the deposit around the second injection holes 8 or 8′ has not grown enough to obstruct a good fuel injection, fuel consumption is unnecessarily deteriorated.

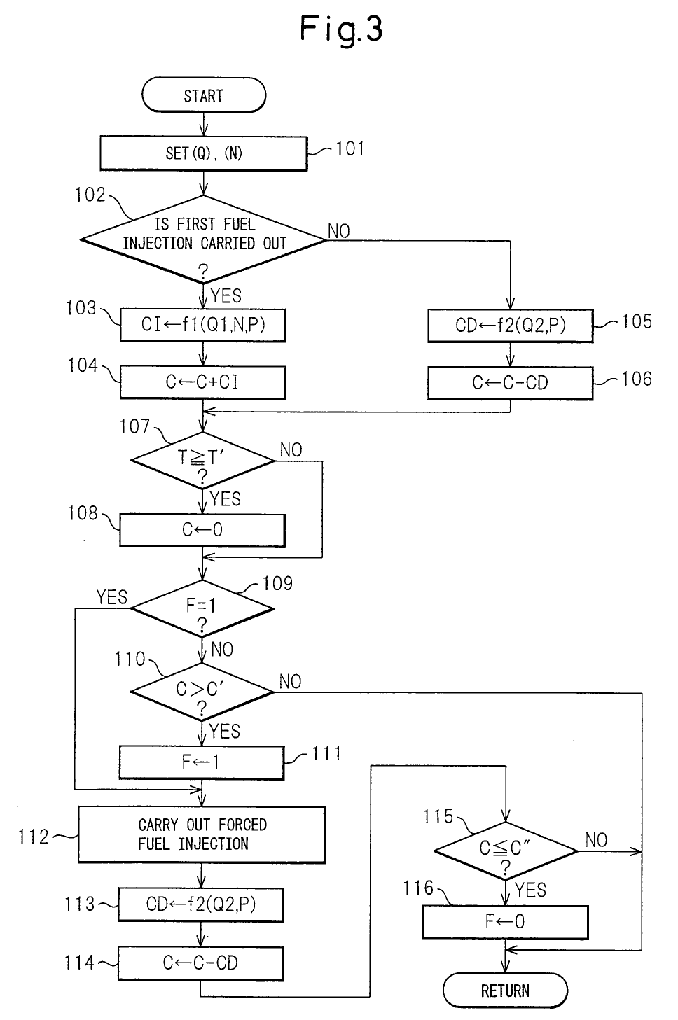

In the present embodiment, according to a flow-chart shown in FIG. 3, the forced fuel injection in which the second injection holes 8 or 8′ are used can be carried out without unnecessary deterioration of fuel consumption. Initially, at step 101, a current required amount of injected fuel (Q) and a current engine speed (N) are set. Next, at step 102, it is determined if the first fuel injection is carried out or not on the basis of the current fuel injection pressure (P) and the current required amount of injected fuel (Q) (and the current engine speed (N)).

When the first fuel injection is carried out, the result of step 102 is positive and the routine goes to step 103. The larger an amount (Q1) (the required amount of fuel (Q) when the first fuel injection is carried out) of fuel injected from the first injection holes 7 or 7′ is, the larger an amount of fuel adhering around the second injection holes 8 or 8′ becomes in the first fuel injection at this time and the larger an amount of deposit produced newly around the second injection holes 8 or 8′ becomes. Accordingly, the larger an amount of fuel injected from the first injection holes 7 or 7′ is, the larger an amount of deposit produced newly (CI) can be estimated.

The higher the temperature near the second injection holes 8 or 8′ of the fuel injector is, the easier the deposit is produced. Therefore, this temperature is estimated on the basis of the amount of fuel (Q1) and the required engine speed (N), and it is preferable that the estimated temperature is taken into account to estimate an amount of deposit produced newly (CI). The slower the flow velocity of fuel injected from the first injection holes 7 or 7′ is, the larger an amount of fuel adhering around the second injection holes 8 or 8′ becomes and the easier the deposit is produced. Therefore, this flow velocity is estimated on the basis of the amount of fuel (Q1) and the fuel injection pressure (P), and it is preferable that the estimated flow velocity is taken into account to estimate an amount of deposit produced newly (CI).

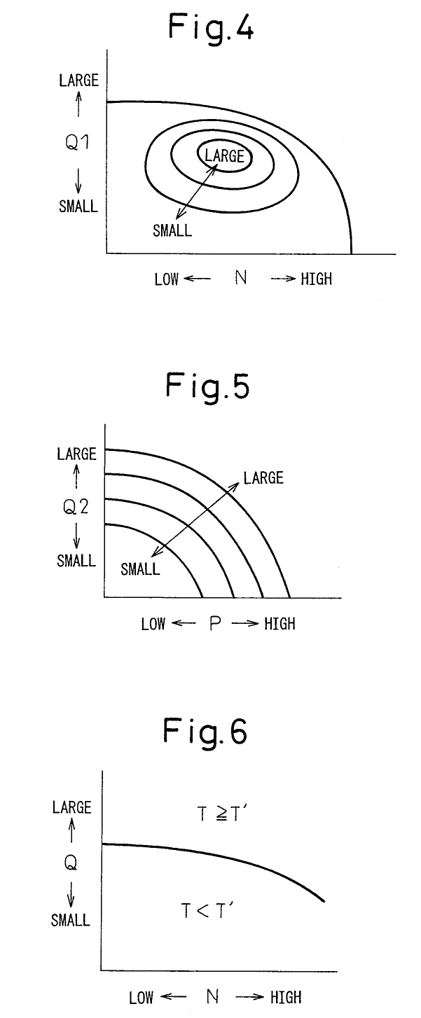

Thus, at step 103, an amount of deposit produced newly (CI) in the first fuel injection at this time is estimated to use a function (f1) of the amount (Q1) of fuel injected from the first injection holes 7 or 7′, the required engine speed (N), and the fuel injection pressure (P). FIG. 4 is a map showing a trend of varying of an amount of deposit produced newly (CI) every the required engine speed (N) and the amount of fuel (Q1) when the fuel injection pressure (P) is specified. Such a map is set every fuel injection pressure in advance and an amount of deposit produced newly (CI) may be estimated from these maps. Next, at step 104, an integrated value (C) is calculated to integrate the amount of deposit (CI).

On the other hand, when the second fuel injection is carried out, the result of step 102 is negative and the routine goes to step 105. When the second fuel injection is carried out, fuel is also injected from the second injection holes 8 or 8′ and therefore a part of deposit around the second injection holes 8 or 8′ is removed. The larger an amount of fuel injected from the second injection holes 8 or 8′ (Q2) (calculated by subtracting an amount of fuel (Q1) injected from the first injection holes from the required amount of fuel (Q)) is, the larger an amount of deposit removed from the second injection holes (CD) in the second fuel injection at this time can be estimated.

The faster the flow velocity of fuel injected from the second injection holes 8 or 8′ is, the larger an amount of deposit is removed from around the second injection holes 8 or 8′ becomes. Therefore, this flow velocity is estimated on the basis of the amount of fuel (Q2) and the fuel injection pressure (P), and it is preferable that the estimated flow velocity is taken into account to estimate an amount of removed deposit (CD).

Thus, at step 105, an amount (CD) of deposit removed by the second fuel injection at this time is estimated to use a function (f2) of the amount (Q2) of fuel injected from the second injection holes 8 or 8′ and the fuel injection pressure (P). FIG. 5 is a map showing a trend of varying of an amount of removed deposit (CD) every the fuel injection pressure (P) and the amount of fuel (Q2). An amount of removed deposit (CD) may be estimated from such a map. Next, at step 106, the amount of removed deposit (CD) is subtracted from the integrated value (C) of the produced deposit.

Incidentally, when the temperature near the second injection holes 8 or 8′ becomes about 230 degrees C., the deposit around the second injection holes 8 or 8′ burns or comes off the fuel injector. Accordingly, the temperature (T) near the second injection holes 8 or 8′ of the fuel injector is estimated on the basis of the required amount of fuel (Q) and the required engine speed (N) set at step 101 and it is determined if the estimated temperature (T) is higher than a set temperature (T′) (230 degrees C.) at step 107. When the result of step 107 is positive, the integrated value (C) of the produced deposit is reduced to 0 at step 108. FIG. 6 is a map showing a trend of varying of the estimated temperature (T) near the second injection holes 8 or 8′ every the required engine speed (N) and the required amount of injected fuel (Q). When the temperature (T) near the second injection holes 8 or 8′ of the fuel injector is close to the set temperature (T′), all the produced deposit may not burn or may not come off. The higher the temperature near the second injection holes 8 or 8′ is, the larger the amount of deposit burned or come off becomes, and thus the amount of burned or come off deposit (CD′) can estimated to use a function (f3(Q, N)) of the required amount (Q) of injected fuel and the required engine speed (N) (or the estimated temperature (T) near the second injection holes 8 or 8′). Therefore, at step 108, the integrated value (C) is not reduced to 0 and the amount of burned or come off deposit (CD′) may be subtracted from the integrated value (C).

Thus, the current integrated value (C) almost corresponds to the amount of deposit around the second injection holes 8 or 8′. At step 109, it is determined if a flag for injecting forcibly fuel (F) is 1. Initially, this result is negative, the routine goes to step 110, and it is determined if the current integrated value (C) is larger than an allowable maximum amount of deposit (C′) in which good fuel injections from the second injection holes 8 or 8′ are guaranteed (or an amount of deposit slightly smaller than this allowable amount). When this result is negative, the routine is stopped. On the other hand, when this result is positive, the flag for injecting forcibly fuel (F) is set 1 at step 111 and a fuel injection in which the second injection holes 8 or 8′ are used is forcibly carried out at step 112.

Next, at step 113, an amount of deposit removed by this forced fuel injection (CD) is calculated in the same way at step 105 and at step 114, the calculated amount of removed deposit (CD) is subtracted from the integrated value (C) of the deposit. Next, at step 115, it is determined if the current integrated value (C) is smaller than a very small set value (C″). When this result is negative, the routine is stopped. Accordingly, the flag for injecting forcibly fuel (F) remains 1 and thus in the next process, the forced fuel injection at step 112 is continuously carried out because the result at step 109 is positive.

When the current integrated value (C) reduces to the very small set value (C″) by the continuous forced fuel injection, the result at step 115 is positive and at step 116, the flag for injecting forcibly fuel (F) is reset 0. Accordingly, the result at step 109 is negative and the forced fuel injection is not carried out until the current integrated value (C) becomes larger than the allowable maximum amount of deposit (C′) and the result at step 110 is positive. Thus, it is restrained that the forced fuel injection in which the second injection holes 8 or 8′ are used is unnecessarily carried out and fuel consumption deteriorates.

Incidentally, at step 102, it is determined which of the first fuel injection, in which the first injection holes 7 or 7′ are used and the second injection holes 8 or 8′ are not used, and the second fuel injection, in which both of the first injection holes 7 or 7′ and the second injection holes 8 or 8′ are used, is carried out on the basis of the required amount of injected fuel (Q). However, this does not limit to the present invention. In the fuel injector shown in FIGS. 1 and 2, if the opening velocity of the valve body 4 or 4′ is very fast, the second fuel injection can be carried out when the required amount of injected fuel (Q) is relatively small. Therefore, the first fuel injection and the second fuel injection can be changed over on the basis of the current engine operating condition, except when the required amount of injected fuel is very small.

However, the opening velocity of the valve body 4 or 4′ is not usually so fast, and thus when the order period of the valve opening is relatively short, the valve body 4 or 4′ must be closed before the valve body is lifted (up to a high lifting amount) so as to open fully the second injection holes 8 or 8′. In such a case, the second fuel injection can not be carried out and thus the first fuel injection is necessarily carried out. On the other hand, in a case where a mechanism which holds the valve body 4 or 4′ in the lifting amount (low lifting amount) at which the second injection holes 8 or 8′ are not opened is not provided, when the order period of the valve opening is relatively long, the lifting amount of the valve body 4 or 4′ becomes the high lifting amount and thus the second fuel injection is necessarily carried out.

The higher the fuel injection pressure is, the shorter the order period of the valve opening required for injecting the same amount of fuel becomes. Accordingly, in such a case where the first fuel injection and the second fuel injection are changed over on the basis of the order period of the valve opening, the higher the fuel injection pressure is, the larger the required amount of injected fuel (Q) when the first fuel injection is changed to the second fuel injection becomes. Namely, if the opening velocity of the valve body 4 or 4′ is constant regardless of the fuel injection pressure, the order period of the valve opening when the first fuel injection is changed to the second fuel injection is constant, and the higher the fuel injection pressure is, the larger the amount of fuel injected for this order period of the valve opening (namely, the required amount of injected fuel (Q)) becomes.

Incidentally, in a case where the required amount of fuel (Q) is injected to be divided into an amount of main fuel injection and an amount of pilot fuel injection, in the flow-chart in FIG. 3, the process at step 102 is carried out in each of the main fuel injection and the pilot fuel injection, the processes of steps 103 and 104 or the processes of steps 105 and 106 are carried out, and the amount of produced deposit or the amount of removed deposit is calculated in each of the main fuel injection and the pilot fuel injection. At step 107, when the temperature (T) near the second injection holes is estimated, the required amount of injected fuel (Q) which is the total of the amount of main fuel injection and the amount of pilot fuel injection is used.

In the present embodiment, the forced fuel injection, in which the second injection holes 8 or 8′ are used, carried out at step 112 of the flow-chart in FIG. 3 is the second fuel injection in which both of the first injection holes 7 or 7′ and the second injection holes 8 or 8′ are used (of course, if a fuel injection in which the second injection holes 8 or 8′ is only used can be carried out in the fuel injector, this fuel injection may be carried out.) If the fuel injected in the second fuel injection contributes combustion, the engine output is unnecessarily increased and thus the drivability deteriorates. Accordingly, it is preferable that the forced second fuel injection is carried out in, for example, an expansion stroke or an exhaust stroke.

Incidentally, in deceleration, fuel-cut is usually carried out. When the fuel-cut is carried out, the throttle valve is closed such that an amount of intake air is small enough not to cause combustion and the forced second fuel injection may be carried out. In this case, it is preferable that the fuel injection time is near the top dead center of intake stroke or compression stroke. Therefore, the fuel is injected certainly into the combustion chamber formed on the top surface of the piston and the fuel sticks hardly on the cylinder-bore. Thus, it can be restrained that the engine oil is diluted by the fuel stuck on the cylinder-bore.

Incidentally, in an internal combustion engine which carries out lean burn like a diesel engine, a NO_{X} storing catalyst apparatus for storing NO_{X} in the exhaust gas is arranged in the exhaust system. The NO_{X} storing catalyst apparatus cannot store NO_{X} without limitation. Thus, before the stored NO_{X} amount reaches the maximum storable amount, regeneration process of the NO_{X} storing catalyst apparatus in which the stored NO_{X} is released and the released NO_{X} is purified to be reduced is required. To carry out this regeneration process, an air-fuel ratio of the exhaust gas flowing into the NO_{X} storing catalyst apparatus must become rich (or stoichiometric).

When the above mentioned forced fuel injection is carried out, the exhaust gas includes a large amount of unburned fuel and thus an air-fuel ratio of the exhaust gas becomes rich. Accordingly, when an air-fuel ratio of the exhaust gas must become rich to carry out the regeneration process of the NO_{X} storing catalyst apparatus, the forced fuel injection (the above-mentioned second fuel injection in later half of an expansion stroke or in an exhaust stroke, or the above-mentioned second fuel injection near a top dead center of intake stroke or compression stroke in engine deceleration) may be carried out. Even if the forced fuel injection is carried out when the regeneration process of the NO_{X} storing catalyst apparatus is not required, the stored NO_{X} is released from the NO_{X} storing catalyst apparatus and the released NO_{X} is purified to be reduced. Therefore, an interval of the regeneration process of the NO_{X} storing catalyst apparatus can be lengthened.

The NO_{X} storing catalyst apparatus also stores SO_{X} like NO_{X} and thus the maximum storable amount of NO_{X} is reduced. Accordingly, when the amount of stored SO_{X} reaches a predetermined amount, a recovery process for releasing SO_{X} from the NO_{X} storing catalyst apparatus is required. In this recovery process, the NO_{X} storing catalyst apparatus must become at about 800 degrees C. and the air-fuel ratio of the exhaust gas must become rich. When the recovery process is required, the above-mentioned forced fuel injection may make the air-fuel ratio become rich.

On the other hand, when the first fuel injection for combustion is carried out, the required amount of injected fuel (Q) may be increased and the first fuel injection may be changed to the second fuel injection, as the forced fuel injection for removing the deposit around the second fuel injection 8 or 8′. In this case, if the required amount of injected fuel is merely increased, the engine output increases and thus the drivability deteriorates. Accordingly, when the required amount of injected fuel is increased, it is preferable that the fuel injection time is delayed not so as to increase the engine output.

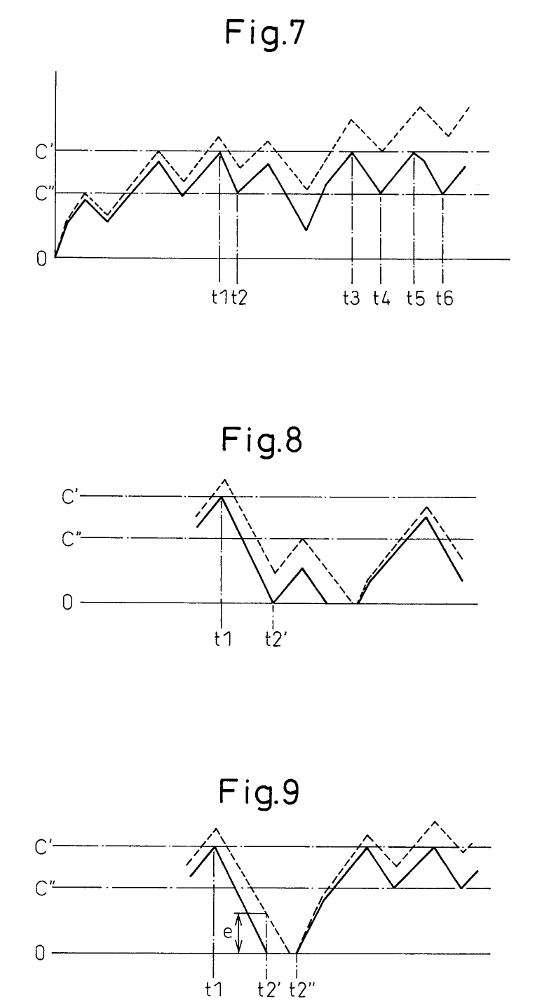

FIG. 7 is a time-chart showing a varying of the integrated value (C) of the deposit when the control of the flow-chart in FIG. 3 is carried out. In FIG. 7, the integrated value (C) reaches the maximum allowable amount of deposit (C′) (a first set amount) at time (t1) and the above-mentioned forced fuel injection is carried out. Therefore, the integrated value (C) reduces and when it reaches the above-mentioned set amount (C″) (a second set amount) at time (t2), the forced fuel injection is stopped. Thus, the forced fuel injection is continuously carried out between the time (t1) and the time (t2), between time (t3) and time (t4), and between time (t5) and time (t6), respectively,

When the integrated value (C) of deposit corresponds relative accurately to the actual amount of deposit around the second injection holes, no problem occurs and an amount of fuel consumed by the forced fuel injection is not so large. However, the integrated value (C) is an estimated value, and when a calculation error, in which the amount of produced deposit (CI) calculated at step 103 is smaller than the correct amount or the amount of removed deposit (CD) calculated at step 105 is larger than the correct amount, occurs and the current integrated value (C) is estimated smaller than the actual amount of deposit showing by a dot line in FIG. 7, the actual amount of deposit around the second injection holes 8 or 8′ exceeds the maximum allowable amount (C′) but the forced fuel injection is not carried out due to the calculation error of the integrated value (C).

This estimated error is accumulated in the integrated value (C) and therefore, the longer an interval of the forced fuel injection is, the larger the actual amount of deposit around the second injection holes 8 or 8′ immediately before the forced fuel injection starts becomes. Thus, the actual amount of deposit exceeds the maximum allowable amount of deposit and decreases the flow rate of fuel injected from the second injection holes 8 or 8. When the actual amount of deposit further increases, the spray penetration of fuel is extremely weaken and the vaporization of fuel becomes insufficiently. Therefore, the exhaust emission deteriorates. Finally, the actual amount of deposit may become an amount which cannot be removed by the forced fuel injection.

To improve this problem, for example, as shown in FIG. 8, the forced fuel injection starting at the time (t1) may not be stopped when the integrated value (C) reaches the second set amount (C″), and the forced fuel injection may be continued until the integrated value (C) reaches zero. Thus, the forced fuel injection is continued until time (t2′). The actual amount of deposit at the time (t2′) does not become zero due to the above-mentioned estimated error but becomes smaller than an amount of deposit in the case where the forced fuel injection is stopped when the integrated value (C) reaches the second set amount (C″). Accordingly, a period until the actual amount of deposit reaches the first set amount (C′) can be lengthened. In this period, the second fuel injection which can decrease the actual amount of deposit would be carried out un-forcedly. Therefore, a possibility in which the actual amount of deposit exceeds the maximum allowable amount of deposit (the first set amount (C′)) can be reduced.

As shown in FIG. 8, if the actual amount of deposit becomes zero by the normal second fuel injection in which the second injection holes are used, the estimated error integrated in the integrated value (C) is cancelled. Such a fuel injection pattern, in which the forced fuel injection is continued until the estimated integrated value (C) becomes zero, may be carried out every when the estimated integrated value (C) reaches the first set amount (C′), or may be carried out when a fuel injection pattern with a small required amount of fuel in which the forced fuel injection is continued until the estimated value (C) reaches the second set amount (C″) is carried out set times (one time or several times). The set times may not be constant.

To improve the aforementioned problem, for example, as shown in FIG. 9, the forced fuel injection started at the time (t1) may not be stopped when the estimated integrated value (C) reduces to the second set amount (C″) and may be continued until a set period (between (t2′) and (t2″)) elapses after the estimated integrated value (C) becomes zero. The actual amount of deposit can perfectly become zero at the time (t2″) by the forced fuel injection during such a set period. Thus, likewise the control of FIG. 8, the possibility in which the actual amount of deposit exceeds the maximum allowable amount of deposit (the first set amount (C′)) can be reduced and in addition, because the estimated integrated value (C) does not become smaller than zero, the estimated integrated value at the time (t2″) becomes zero corresponding to the actual amount of deposit at this time and therefore the integrated estimated error (e) in the integrated value can be cancelled. Thus, the problem, in which the forced fuel injection is not started when the actual amount of deposit exceeds the maximum allowable amount of deposit (C′), can be improved.

Such a fuel injection pattern, in which the forced fuel injection is continued until the set period elapses after the estimated integrated value (C) becomes zero, may be carried out every when the estimated integrated value (C) reaches the first set amount (C′), or may be carried out when a fuel injection pattern with a small required amount of fuel in which the forced fuel injection is continued until the estimated value (C) reaches the second set amount (C″) is carried out set times (one time or several times). The set times may not be constant. The longer the set period (cycle times, time, or the like) becomes, the more certainly the integrated estimated error (e) can be cancelled. However, it is preferable that the set period is shortened to decrease the amount of fuel injected by the forced fuel injection.

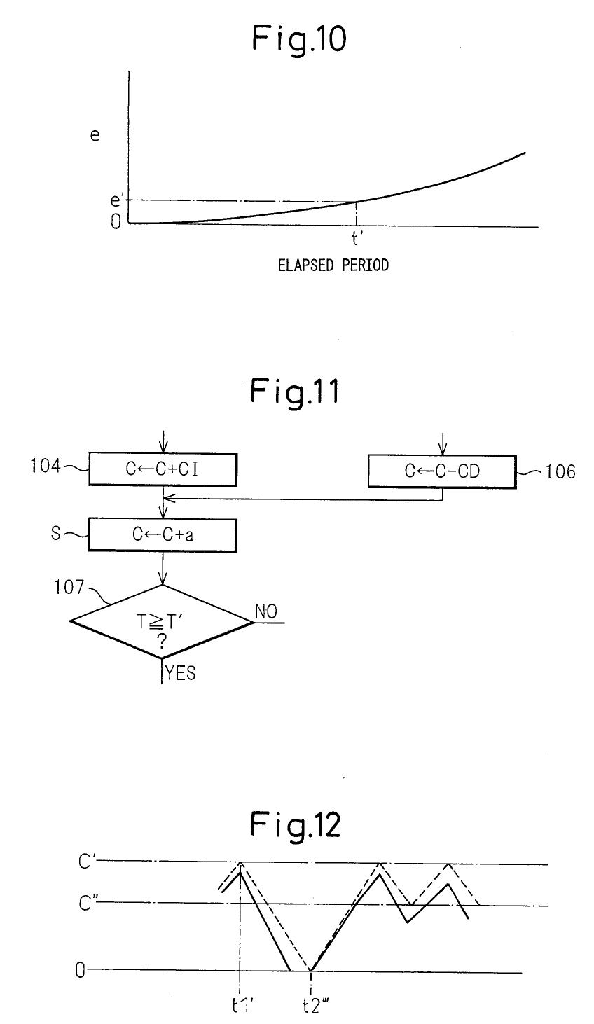

As shown in FIG. 10, the longer the period (cycle times or time) elapsed from when the integrated estimated error (e) is zero becomes, the larger the integrated estimated error (e) becomes. Therefore, for example, a period for continuing the forced fuel injection to cancel a set integrated estimated error (e′) is set as the above-mentioned set period and the fuel injection pattern in which the forced fuel injection is continued until the estimated integrated value (C) becomes the second set amount (C″) may be carried out in a period while the integrated estimated error changes from zero to the set value (e′). When the integrated estimated error becomes the set value (e′), the fuel injection pattern in which the forced fuel injection is continued until the set period elapses after the estimated integrated value (C) becomes zero may be carried out such that the estimated integrated value becomes zero. The fuel injection pattern in which the forced fuel injection is continued until the estimated integrated value (C) becomes zero as shown in FIG. 8 may be carried out every when the estimated integrated error becomes the set value (e′). Of course, the number of times of the fuel injection pattern in which the forced fuel injection is continued until the estimated integrated value (C) becomes the second set amount (C″) may be set on the basis of the period while the estimated integrated error changes from zero to the set value (e′).

FIG. 11 is a modification of the flow-chart of FIG. 3. In the modification, after the amount of deposit produced newly (CI) is integrated at step 104 or the amount of removed deposit (CD) is subtracted at step 106, an increasing correction value (a) is added to the current integrated value (C) at step S. Thus, if the integrated value (C) is corrected so as to increase, the estimated integrated value (C) does not become smaller than the actual amount of deposit. Accordingly, as shown in FIG. 12, when the corrected integrated value (C) as shown by a dot line reaches the maximum allowable amount of deposit (C′) at the time (t1′), the forced fuel injection is started and thus the actual amount of deposit does not exceed the maximum allowable amount of deposit (C″). This forced fuel injection may be always carried out until the corrected integrated value (C) becomes the second set amount (C″). However, if the forced fuel injection is continued until the corrected integrated value (C) shown by the dot line becomes zero, the corrected integrated value (C) becomes zero corresponding to the actual amount of deposit at the time (t2′″) and thus it is prevent that the integrated correction amount of the integrated value becomes large excessively.

This integrated correction amount corresponds to the above mentioned estimated integrated error and thus the fuel injection pattern in which the forced fuel injection is continued until the corrected integrated value (C) becomes zero may be carried out intermittently in the aforementioned way. The increasing correction amount (a) may be constant and it may be added to the integrated value (C) every repetition of the flow-chart. Instead that the integrated value (C) is corrected so as to increase by the increasing correction amount (a), the amount of deposit produced newly (CI) calculated at step 103 may be corrected to be multiplied by another correction value (a constant larger than 1) and the amount of removed deposit (CD) calculated at steps 105 and 113 may be corrected to be multiplied by another correction value (a constant larger than 0 and smaller than 1).

### DESCRIPTION OF REFERENCE NUMERALS

1, 1′ Fuel Injector
4, 4′ Valve Body
7, 7′ First Injection Hole
8, 8′ Second Injection Hole

1. A fuel injection control device for an internal combustion engine which controls a fuel injector for injecting fuel directly into the cylinder, which has a first injection hole and a second injection hole, so as to change over a first fuel injection, in which said first injection hole is used and said second injection hole is not used, and a second fuel injection, in which both of said first injection hole and said second injection hole are used, characterized in that when said first fuel injection is carried out, an amount of deposit produced newly around said second injection hole is estimated on the basis of an amount of fuel injected from at least said first injection hole, the amount of produced deposit estimated every time said first fuel injection is carried out is integrated, when said integrated value of the amount of deposit reaches a first set value, a fuel injection in which said second injection hole is used is carried out to remove the deposit.

2. A fuel injection control device for an internal combustion engine according to claim 1, characterized in that when fuel is injected from said second injection hole, an amount of deposit removed from around said second injection hole is estimated on the basis of an amount of fuel injected from at least said second injection hole, the estimated amount of removed deposit is subtracted from said integrated value of the amount of deposit.

3. A fuel injection control device for an internal combustion engine according to claim 1 or 2, characterized in that when a measured or estimated temperature near said second injection hole of said fuel injector becomes equal to or higher than a set temperature, said integrated value of the amount of deposit is decreased.

4. A fuel injection control device for an internal combustion engine according to any one of claims 1-3, characterized in that said fuel injection when said integrated value of the amount of deposit reaches said first set value, in which said second injection hole is used, is carried out near an intake or compression top dead center when combustion is stopped temporarily.

5. A fuel injection control device for an internal combustion engine according to any one of claims 1-3, characterized in that said fuel injection when said integrated value of the amount of deposit reaches said first set value, in which said second injection hole is used, is carried out in an expansion or exhaust stroke when exhaust gas that has an air-fuel ratio richer than the stoichiometric air-fuel ratio is required for the engine exhaust system.

6. A fuel injection control device for an internal combustion engine according to any one of claims 1-5, characterized in that in said fuel injection when said integrated value of the amount of deposit reaches said first set value, in which said second injection hole is used, an amount of deposit removed from around said second injection hole is estimated on the basis of an amount of fuel injected from at least said second injection hole, the estimated amount of removed deposit is subtracted from said integrated value of the amount of deposit, said fuel injection when said integrated value of the amount of deposit reaches said first set value, in which said second injection hole is used, is carried out continuously until said integrated value of the amount of deposit becomes a second set value larger than zero and smaller than said first set value.

7. A fuel injection control device for an internal combustion engine according to any one of claims 1-5, characterized in that in said fuel injection when said integrated value of the amount of deposit reaches said first set value, in which said second injection hole is used, an amount of deposit removed from around said second injection hole is estimated on the basis of an amount of fuel injected from at least said second injection hole, the estimated amount of removed deposit is subtracted from said integrated value of the amount of deposit, said fuel injection when said integrated value of the amount of deposit reaches said first set value, in which said second injection hole is used, is carried out continuously until said integrated value of the amount of deposit becomes zero.

8. A fuel injection control device for an internal combustion engine according to any one of claims 1-5, characterized in that in said fuel injection when said integrated value of the amount of deposit reaches said first set value, in which said second injection hole is used, an amount of deposit removed from around said second injection hole is estimated on the basis of an amount of fuel injected from at least said second injection hole, the estimated amount of removed deposit is subtracted from said integrated value of the amount of deposit, said fuel injection when said integrated value of the amount of deposit reaches said first set value, in which said second injection hole is used, is carried out continuously until a set period elapses after said integrated value of the amount of deposit becomes zero.

9. A fuel injection control device for an internal combustion engine according to claim 6, characterized in that when a first fuel injection pattern, in which said fuel injection when said integrated value of the amount of deposit reaches said first set value, in which said second injection hole is used, is carried out continuously until said integrated value of the amount of deposit reaches said second set value, is carried out one or several set time(s), a second fuel injection pattern, in which said fuel injection when said integrated value of the amount of deposit reaches said first set value, in which said second injection hole is used, is carried out continuously until a set period elapses after said integrated value of the amount of deposit becomes zero, is carried out.

10. A fuel injection control device for an internal combustion engine according to any one of claims 1-5, characterized in that said integrated value of the amount of deposit is corrected so as to increase due to an estimated error of said integrated value.

11. A fuel injection control device for an internal combustion engine according to claim 6, characterized in that said integrated value of the amount of deposit is corrected so as to increase due to an estimated error of said integrated value.

12. A fuel injection control device for an internal combustion engine according to claim 11, characterized in that when a first fuel injection pattern, in which said fuel injection when said integrated value of the amount of deposit reaches said first set value, in which said second injection hole is used, is carried out continuously until said integrated value of the amount of deposit reaches said second set value, is carried out one time or set times, a second fuel injection pattern, in which said fuel injection when said integrated value of the amount of deposit reaches said first set value, in which said second injection hole is used, is carried out continuously until the integrated value of the amount of deposit becomes zero, is carried out.

13. A fuel injection control device for an internal combustion engine according to claim 7, characterized in that said integrated value of the amount of deposit is corrected so as to increase due to an estimated error of said integrated value.
